(19) United States
(12) Patent Application Publication
(10) Pub. No.: US 2015/0135468 A1
(43) Pub. Date: May 21, 2015

(54) WIPER BLADE ASSEMBLY

(71) Applicant: CAP CORPORATION, Dalseo-gu (KR)

(72) Inventor: Tae Hun KIM, Dalseo-gu (KR)

(73) Assignee: CAP CORPORATION, Dalseo-gu (KR)

(21) Appl. No.: 14/133,200

(22) Filed: Dec. 18, 2013

(30) Foreign Application Priority Data
Nov. 19, 2013 (KR) 10-2013-0140831

(51) Int. Cl. B60S 1/38

(52) U.S. Cl. CPC B60S 1/381
USPC 15/250.201

(57) ABSTRACT

A wiper blade assembly is provided with an adhering member for clearing a glass surface, and a channel rail configured to retain the adhering member. The wiper further includes an elongate elastic member disposed above the channel rail having at least one slot formed therethrough, and configured to receive a protrusion extending vertically from the channel rail through the at least one slot. A symmetrical wind spoiler is disposed about the elastic member, and an integral channel rail fixing unit is embedded within the wind spoiler. The channel fixing unit defines channel rail support portions, vertical extensions extending from each of the channel rail support portions, and a connecting portion extending from each of the vertical extensions, wherein the channel rail support portions engage the protrusion and define a thickness greater than a thickness of the connecting portion.

### CROSS-REFERENCE TO RELATED APPLICATIONS

This application is based on and claims priority from Korean Patent Application No. 10-2013-0140831, filed on Nov. 19, 2013 in the Korean Intellectual Property Office, the disclosure of which is incorporated herein in its entirety by reference.

### TECHNICAL FIELD

The present disclosure relates to a wiper blade assembly, and more particularly, to a wiper blade assembly having a structure capable of allowing an adhering member and a spoiler to freely move against each other.

### BACKGROUND

A wiper blade assembly for wiping away rain, in the case of rain, or removing foreign materials to secure a driver's visual field is disposed in a wind shield of a vehicle. The wiper blade assembly is connected to a wiper arm connected to a driving shaft connected to a wiper driving motor of the vehicle to be driven.

Here, the wiper arm and the wiper blade assembly are connected to each other through a wiper connector part. In general, the wiper blade assembly includes a clamp, to which the connector member is coupled, and the wiper arm is coupled to the connector member in a state in which the connector member is coupled to the clamp.

Meanwhile, the wiper blade assembly may be classified into a conventional type or a flat type according to the structure of a blade.

A typical wiper blade assembly includes an adhering member for wiping any foreign materials off of a windshield of a vehicle, an elastic member supporting the adhering member, and a cover member covering either end of the elastic member.

The typical wiper blade assembly also includes a coupling cover coupled to the elastic member, and the coupling cover may also be coupled to an adaptor.

However, in the case of a typical wiper blade assembly, the movement of the cover member (or a spoiler) is not free from the adhering member during the operation of the wiper blade.

More specifically, a typical wiper blade has an adhering member bent with a predetermined curvature, and a center portion of the adhering member is a predetermined distance from the surface of a windshield of a vehicle while the wiper blade is not being driven. On the other hand, during the operation of the wiper blade assembly, the adhering member is deflected such that the entire length is placed in contact with the surface of the windshield and wipes the surface of the windshield.

The curvature of the adhering member may vary from when the wiper blade assembly is being driven to when the wiper blade assembly is not being driven. However, if the cover member is not free from the movement of the adhering member, the movement of the cover member may be considerably limited even though the curvature of the adhering member can vary.

As a result, the cover member may be damaged related to stresses caused by the bending of each of the components. The limited movement of the cover member may also interfere with the variation of the curvature of the adhering member, and may thus adversely affect the wiping performance of the adhering member.

Therefore, Applicant presents herein a wiper blade assembly having a new structure, i.e., a wiper blade assembly with a different structure from that of the patented wiper blade assembly for coupling an adhering member, an elastic member and a clamp.

### SUMMARY

Aspects of the present disclosure provide a wiper blade assembly having a structure capable of allowing an adhering member and a spoiler to freely move against each other.

The objects of the present disclosure are not limited thereto, and the other objects of the present invention will be described in or be apparent from the following description of the embodiments.

In accordance with an aspect of the present disclosure, the above and other objects can be accomplished by providing a wiper blade assembly comprising: an adhering member; an elongate elastic member configured to support the adhering member; a channel rail configured to be coupled to the adhering member; and spoilers configured to cover the elastic member and include channel rail fixing units which fix the channel rail, wherein each of the channel rail fixing units includes a channel rail support unit supporting the channel rail. Each of the channel rail fixing units further includes first-directional extensions extended from the channel rail support unit in a first direction, and a first-directional extension connecting portion connected to the first-directional extensions, and the first-directional extensions are thinner than the channel rail support unit.

Further, in at least one embodiment, the wiper blade assembly first-directional extensions are vertical extensions, and the first-directional extension connecting portions are vertical extension connecting portions. The channel rail support unit includes a first channel rail support and a second channel rail support disposed in parallel with the first channel rail support, and the vertical extensions include a first vertical extension vertically extended from the first channel rail support and a second vertical extension vertically extended from the second channel rail support. The vertical extension connecting portions also include a first vertical extension connecting portion connected to the first vertical extension and a second vertical extension connecting portion connected to the second vertical extension.

Further, in at least one embodiment, the wiper blade assembly elastic member comprises a first elastic element, a second elastic element disposed in parallel with the first elastic element, and a channel rail insertion hole disposed between the first elastic element and the second elastic element, and the channel rail fixing units fix the channel rail with a predetermined portion of the channel rail inserted into the channel rail insertion hole.

Further, in at least one embodiment, the wiper blade assembly channel rail comprises a body, a channel rail protrusion disposed at an upper part of the channel rail, and a connecting portion connecting the body and the channel rail protrusion. Each of the channel rail fixing units comprises a channel rail protrusion receiving part into which the channel rail protrusion is inserted, and the channel rail is coupled to the channel rail fixing units by inserting the channel rail protrusion into the channel rail protrusion receiving part.

Further, in at least one embodiment, the wiper blade assembly channel rail support unit includes a first channel rail support, a second channel rail support disposed in parallel with the first channel rail support, and an insertion hole disposed between the first channel rail support and the second channel rail support, and the channel rail is coupled to the channel rail fixing units by inserting the channel rail protrusion into the channel rail protrusion receiving part and coupling the connecting portion into the insertion hole.

Further, in at least one embodiment, the wiper blade assembly channel rail protrusion has a contact surface formed at a bottom thereof and contacts a surface of the channel rail support. The channel rail support unit also has a contact surface formed at a top thereof and contacting a surface of the channel rail protrusion, and the contact surface of the channel rail protrusion and the contact surface of the channel rail support unit contact each other.

Further, in at least one embodiment, the wiper blade assembly channel rail fixing units are respectively formed in one body with the spoilers and the channel rail fixing units and the channel rail are formed of a plastic material.

Further, in at least one embodiment, the wiper blade assembly defines a thickness (d1) of the channel rail support unit and a thickness (d2) of the first-directional extension connecting portion having a ratio d2:d1 of about 1:0.1 to 1:0.9.

Further, in the wiper blade assembly of the present disclosure, a rigidity of the spoilers and a rigidity of the channel rail fixing units have a ratio of 1:1.05 to 1:1.10.

Further, in the wiper blade assembly of the present invention, the channel rail fixing units slidably move along the channel rail.

According to the present disclosure, channel rail fixing units can be prevented from interfering with the pressing pressure during the operation of a wiper by appropriately limiting the rigidity of the channel rail fixing units.

In addition, one or more vertical extension connecting portions of a channel rail support unit can be prevented from interfering with the pressing pressure during the operation of a wiper by appropriately limiting the thickness of the vertical extension connecting portions.

### BRIEF DESCRIPTION OF THE DRAWINGS

FIG. 1A is a coupled perspective view illustrating a wiper blade assembly according to an embodiment.

FIG. 1B is an exploded perspective view illustrating the wiper blade assembly.

FIG. 2A is a coupled perspective view illustrating the spoilers 500, the elastic member 700 and the channel rail 800 of the wiper blade assembly 10.

FIG. 2B is an exploded perspective view illustrating the spoilers 500, the elastic member 700 and the channel rail 800 of the wiper blade assembly 10.

FIG. 3A is an exploded cross-sectional view taken along line I-I of FIG. 2A.

FIG. 3B is a coupled cross-sectional view taken along line I-I of FIG. 2A.

FIG. 4A is a cross-sectional view illustrating a first modified example of the second channel rail fixing unit 600b.

FIG. 4B is a cross-sectional view illustrating a second modified example of the second channel rail fixing unit 600b.

FIG. 4C is a cross-sectional view illustrating a third modified example of the second channel rail fixing unit 600b.

FIGS. 5A and 5B are schematic views comparing the movement of an adhering member when a wiper is being driven and the movement of the adhering member when the wiper is not being driven.

FIG. 6 is a coupled cross-sectional view of an alternative embodiment taken along line I-I of FIG. 2A.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Advantages and features of the present disclosure and methods of accomplishing the same may be understood more readily by reference to the following detailed description of exemplary embodiments and the accompanying drawings. The present invention may, however, be embodied in many different forms and should not be construed as being limited to the exemplary embodiments set forth herein.

Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

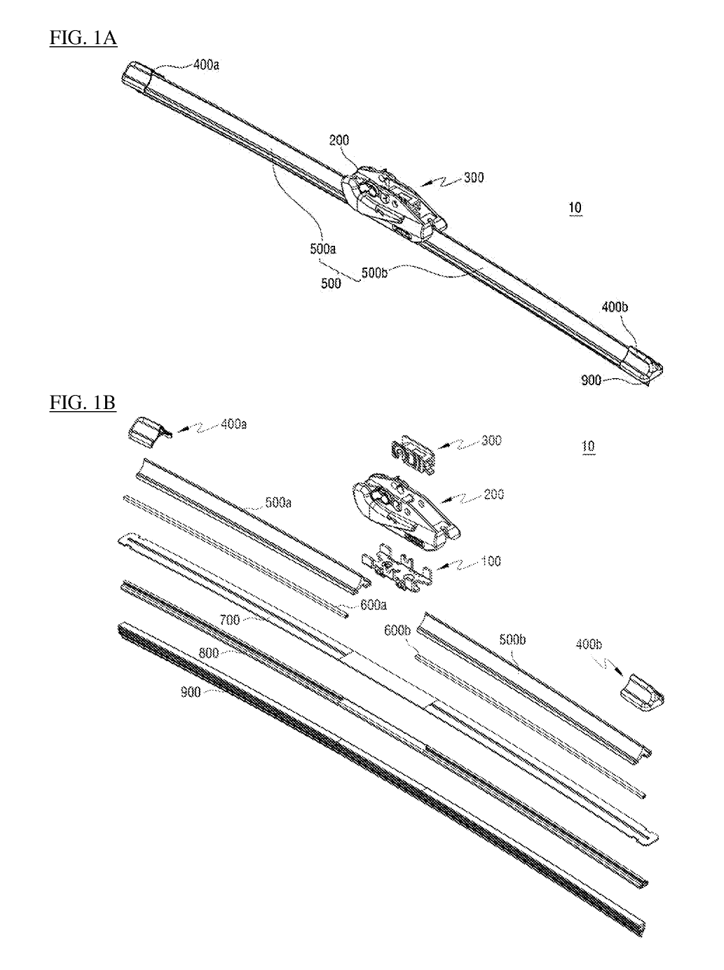

FIG. 1A is a coupled perspective view illustrating a wiper blade assembly according to an embodiment, and FIG. 1B is an exploded perspective view illustrating the wiper blade assembly.

Referring to FIGS. 1A and 1B, a wiper blade assembly 10 includes an adhering member 900 which is formed of a rubber material and is placed in contact with the wind shield of a vehicle, an elongate elastic member 700 which supports the adhering member 900, and a pair of spoilers 500 which cover the elastic member 700.

The wiper blade assembly 10 also includes a clamp 100 connected to the elastic member 700 and an adaptor coupled to the clamp 100. The adaptor 200 is connected to a connector 300. The wiper blade assembly 10 is coupled to a wiper arm (not illustrated) of the vehicle via the connector 300.

As illustrated in FIGS. 1A and 1B, the wiper blade assembly 10 also includes a channel rail 800 coupled to the adhering member 900. Once coupled to the elastic member 700, the channel rail 800 can be prevented by first and second channel rail fixing units 600a and 600b from being detached from the elastic member 700.

That is, the channel rail 800 is inserted into the elastic member 700, and is also inserted into the first and second channel rail fixing units 600a and 600b. As a result, the channel rail 800 can be prevented from being detached from the elastic member 700.

The wiper arm is coupled to the connector 300 so that the wiper blade assembly 10 can perform a wiping operation by using power applied thereto from the wiper arm.

The spoilers 500 may be respectively formed in one body with the first and second channel rail fixing units 600a and 600b by double extrusion.

That is, for convenience, the spoilers 500 and the first and second channel rail fixing units 600a and 600b are illustrated in FIG. 1B as being separate from each other, but may actually be formed by double extrusion to be fixed to each other.

For example, the first and second channel rail fixing units 600a and 600b and the channel rail 800 may be formed of a plastic material. In this example, the mobility of the first and second channel rail fixing units 600a and 600b against the surface of the channel rail 800 can be improved, and thus, during the operation of a wiper blade, the first and second channel rail fixing units 600a and 600b and the channel rail 800 can smoothly move against each other.

That is, by forming the first and second channel rail fixing units 600a and 600b and the channel rail 800 of a plastic material, the coefficient of friction at the contact surfaces (or the interfaces) between the channel rail 800 and the first and second channel rail fixing units 600a and 600b can be reduced, thereby facilitating a slidable movement of the channel rail 800 and the first and second channel rail fixing units 600a and 600b against each other.

An improved or facilitated mobility of the channel rail 800 and the first and second channel rail fixing units 600a and 600b against each other may mean that the first and second channel rail fixing units 600a and 600b may slidably move against the channel rail 800.

An improved mobility of the channel rail 800 and the first and second channel rail fixing units 600a and 600b against each other may result in an improved mobility of the adhering member 900, which is coupled to the channel rail 800. The improved mobility of the first and second channel rail fixing units 600a and 600b may also result in an improved mobility of the spoilers 500, which are respectively formed in one integral body with the first and second channel rail fixing units 600a and 600b, and the adhering member 900 against each other.

In the case of a related-art wiper blade, since the movement of a cover member is not free from the movement of an adhering member, the movement of the cover member may be limited even with variations in the curvature of the adhering member, and as a result, the cover member may be damaged. Loads imparted from a wiper arm to conform the wiper blade curvature to a windshield may cause both bending and shear stresses in the components. Since each component may have different shapes and materials, bending profiles may differ across each. As such, transverse shear stress can build up in the components. In addition, the limited movement of the cover member may interfere with the change of the curvature of the adhering member and may thus adversely affect the wiping performance of the adhering member.

The aforementioned problems associated with a related-art wiper blade may be addressed by improving the mobility of the spoilers 500 and the adhering member against each other. By allowing for mobility, or relative slip between the components, the above-mentioned shear stress may be avoided.

In FIGS. 1A and 1B, reference numerals 400a and 400b indicate end covers which are coupled to the spoilers 500. The present disclosure is not limited to the presence of the end covers 400a and 400b.

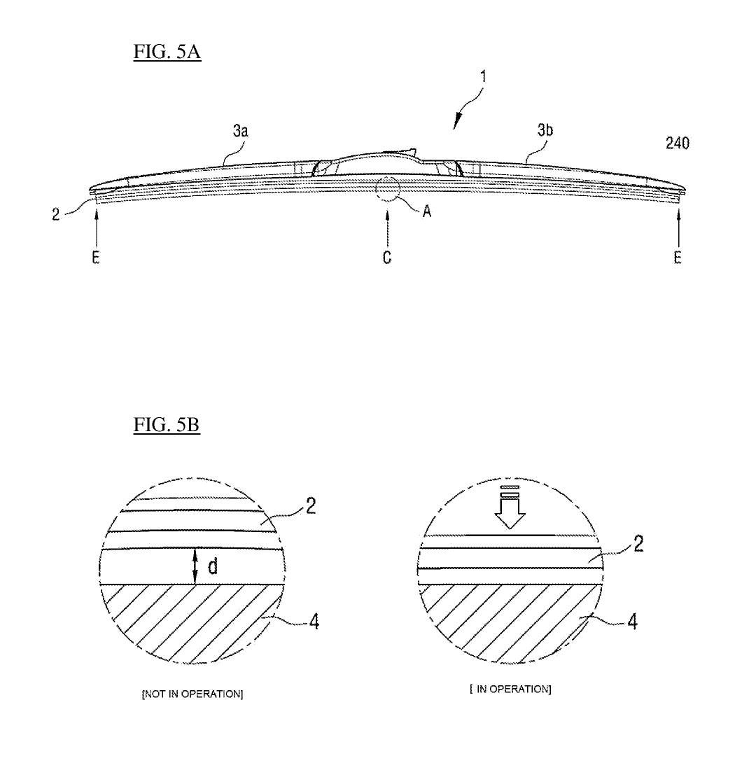

In an embodiment in which the channel rail 800 is inserted into a predetermined portion of the elastic member 700 and is also inserted into the first and second channel rail fixing units 600a and 600b so as to prevent the channel rail 800 from being detached from the elastic member 700, the pressing or pressure properties of a wiper blade may be important, which will hereinafter be described with reference to FIGS. 5A and 5B.

FIGS. 5A and 5B are schematic views comparing the movement of an adhering member when a wiper is being driven and the movement of the adhering member when the wiper is not being driven.

Referring to FIG. 5A, a typical wiper blade 1 has an adhering member 2 bent with a predetermined curvature.

The wiper blade 1 itself may have a constant predetermined curvature. Alternatively, the curvature of the wiper blade 1 may vary from a central part A to an edge part E of the wiper blade 1.

Referring to FIG. 5B, when a wiper is not being driven, a windshield 4 and the adhering member 2 are a predetermined distance d apart from each other. On the other hand, when the wiper is being driven, the adhering member 2 is placed in contact with the windshield 4 along its length and wipes the windshield 4.

That is, while the wiper is being driven, a predetermined pressing pressure is applied to the wiper blade 1 such that the adhering member 2 can contact the windshield 4.

In the embodiments illustrated in FIGS. 1A and 1B, the first and second channel rail fixing units 600a and 600b may resist the pressing pressure on the adhering member 900.

In order for the first and second channel rail fixing units 600a and 600b to not interfere with the pressing pressure on the adhering member 900, the rigidity of the first and second channel rail fixing units 600a and 600b may be predetermined. In this way, the first and second channel rail fixing units 600a and 600b do not interfere with the wiping operation of a wiper.

More specifically, the rigidity of the first and second channel rail fixing units 600a and 600b may be determined n consideration of the rigidity of the spoilers 500. For example, the rigidity of the first and second channel rail fixing units 600a and 600b and the rigidity of the spoilers 500 may have a ratio of about 1:1.05 to 1:1.10.

In response to the ratio of the rigidity of the first and second channel rail fixing units 600a and 600b and the rigidity of the spoilers 500 being less than 1:1.05, the first and second channel rail fixing units 600a and 600b may not be sufficiently rigid to properly fix the channel rail 800. On the other hand, in response to the ratio of the rigidity of the first and second channel rail fixing units 600a and 600b and the rigidity of the spoilers 500 being greater than 1:1.10, the first and second channel rail fixing units 600a and 600b may undesirably interfere with the pressing pressure on the adhering member 900.

For example, the spoilers 500 may have a rigidity of Shore A 85-90, and the first and second channel rail fixing units 600a and 600b may have a rigidity of Shore A 90-95.

According to the examples illustrated in FIGS. 1A and 1B, it is possible to realize a wiper blade in which the channel rail 800 can be prevented from being detached from the elastic member 700 by being inserted into the elastic member 700 and also into the first and second channel rail fixing units 600a and 600b, and in which the movement of the adhering member 900 can be free from the spoilers 500.

In addition, it is possible to prevent the first and second channel rail fixing units 600a and 600b from interfering with the pressing pressure on the adhering member 900 by determining the rigidity of the first and second channel rail fixing units 600a and 600b in consideration of the rigidity of the spoilers 500.

Each of the first and second channel rail fixing units 600a and 600b may include a channel rail support unit, which is provided for strengthening the coupling between the first and second channel rail fixing units 600a and 600b and the spoilers 500, which are respectively formed in one body with the first and second channel rail fixing units 600a and 600b. The channel rail support unit may include a vertical extension connecting portion, which, however, may interfere with the pressing pressure on the adhering member 900.

The thickness of the vertical extension connecting portion may be determined such that the vertical extension connecting portion may not cause too much resistance and thereby interfere with the pressing pressure on the adhering member 900. The vertical extension connecting portion will be described later in greater detail.

The structure of the wiper blade assembly 10 will hereinafter be described in greater detail.

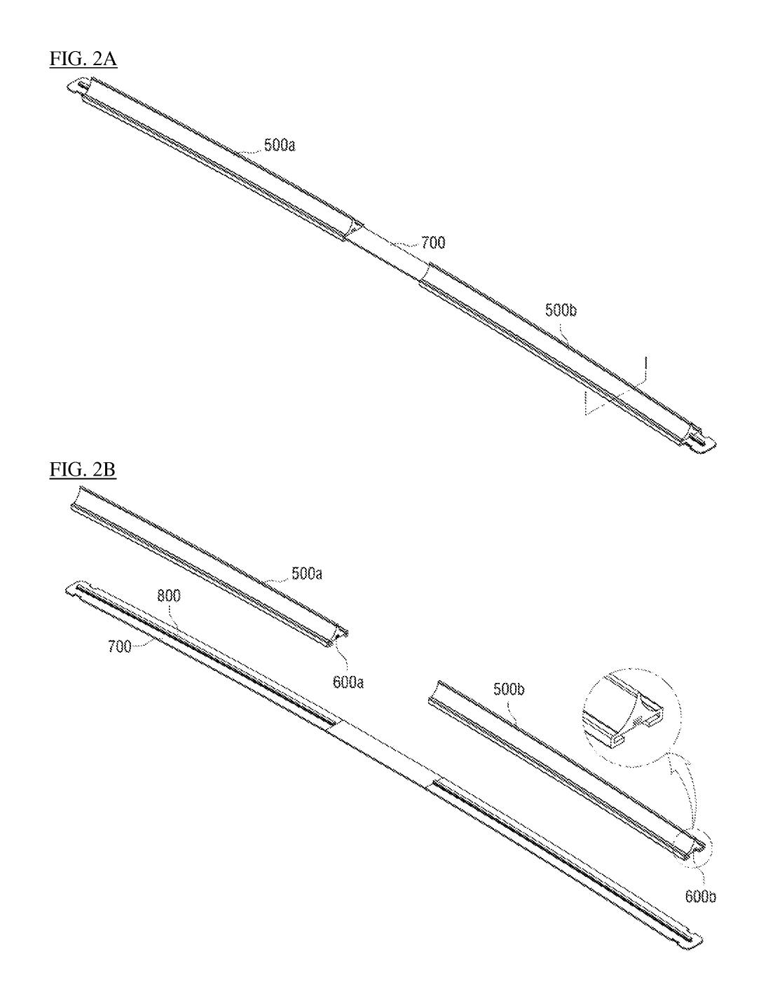

FIG. 2A is a coupled perspective view illustrating the spoilers 500, the elastic member 700 and the channel rail 800 of the wiper blade assembly 10, and FIG. 2B is an exploded perspective view illustrating the spoilers 500, the elastic member 700 and the channel rail 800 of the wiper blade assembly 10.

For convenience, the adhering member 900 illustrated in FIGS. 1A and 1B is omitted from FIGS. 2A and 2B. Even though not specifically illustrated, the adhering member 900 may be inserted into, and thus coupled to, the channel rail 800.

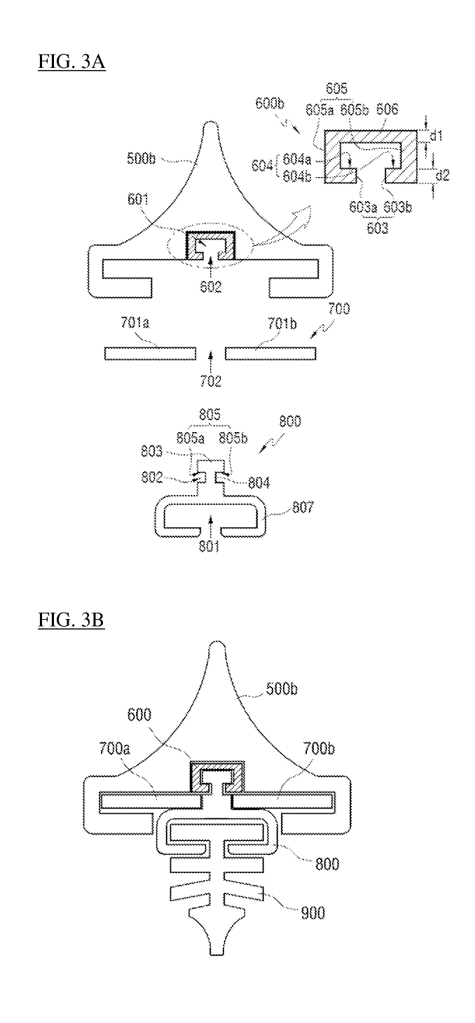

More specifically, as illustrated in FIG. 3A, the channel rail 800 includes an adhering member insertion part 801. The adhering member 900 may be coupled to the channel rail 800 by being inserted into the adhering member insertion part 801. In at least one embodiment, the adhering member 900 may be slidably engaged into an open portion of the channel rail 800.

Referring to FIGS. 2A and 2B, the spoilers 500 include first and second spoilers 500a and 500b. The first and second spoilers 500a and 500b may be formed by double extrusion to be fixed to the first and second channel rail fixing units 600a and 600b, respectively. In such a configuration, the channel rail fixing units may each comprise an integral channel embedded within a respective spoiler.

Once coupled to the elastic member 700, the channel rail 800 may be prevented from being detached from the elastic member 700 by the first and second channel rail fixing units 600a and 600b. It will be described later in detail how the first and second channel rail fixing units 600a and 600b, the elastic member 700 and the channel rail 800 are coupled to one another with reference to FIGS. 3A and 3B.

The first and second spoilers 500a and 500b are formed in one body with, and thus fixed to, the first and second channel rail fixing units 600a and 600b, respectively. The channel rail 800 is insertable through the elastic member 700 and is also coupled to the first and second channel rail fixing units 600a and 600b. Accordingly, the channel rail 800 can be prevented from being detached from the elastic member 700. In at least one embodiment, the wind spoilers each define a symmetrical shape having an apex and extending portions that cover outer edges of the elastic member.

It will hereinafter be described how the spoilers 500, the elastic member 700 and the channel rail 800 are coupled to one another.

FIG. 3A is an exploded cross-sectional view taken along line I-I of FIG. 2A, and FIG. 3B is a coupled cross-sectional view taken along line I-I of FIG. 2A.

Referring to FIGS. 3A and 3B, the second spoiler 500b and the second channel rail fixing unit 600b are integrally formed in one body, and thereby fixed to each other. The second spoiler 500b and the second channel rail fixing unit 600b may be formed in one body with each other by double extrusion, or co-extrusion.

The elastic member 700 includes a first elastic part 701a, a second elastic part 701b disposed in parallel with the first elastic part 701a, and a channel rail insertion hole 702 disposed between the first elastic part 701a and the second elastic part 701b. In at least one embodiment, the insertion hole 702 comprises an elongated slot formed through the elastic member 700.

The channel rail 800 includes a body 807 and the adhering member insertion part 801 disposed below the body 807. In at least one embodiment the body 807 comprises a closed portion configured to abut the elastic member 700, and an open portion directed away from the elastic member 700. By inserting the adhering member 900 into the adhering member insertion part 801, the adhering member 900 may be retained within the channel rail 800.

The channel rail 800 also includes a channel rail protrusion 803 which is inserted into, and thus supported by, the second channel rail fixing unit 600b, and a connecting portion 804 which connects the body 807 and the channel rail protrusion 803.

The channel rail protrusion 803 may include a contact surface 805 which is provided at the bottom of the channel rail protrusion 803 and contacts one surface of the second channel rail fixing unit 600b.

Referring further to FIGS. 3A and 3B, the second channel rail fixing unit 600b, which is coupled to the channel rail 800, includes a channel rail protrusion receiving part, or recess, 601. By inserting the channel rail protrusion 803 of the channel rail 800 into the channel rail protrusion receiving part 601 of the second channel rail fixing unit 600b, the channel rail 800 may be coupled to the second channel rail fixing unit 600b. In at least one embodiment, and opening of the receiving part 601 is in alignment with the insertion hole 702 of the elastic member 700.

The second channel rail fixing unit 600b may also include a channel rail support unit 603. The channel rail support unit 603 includes a first channel rail support 603a, a second channel rail support 603b disposed in parallel with the first channel rail support 603a, and an insertion hole 602 disposed between the first channel rail support 603a and the second channel rail support 603b.

That is, the channel rail protrusion 803 of the channel rail 800 may be inserted into the channel rail protrusion receiving part 601 of the second channel rail fixing unit 600b. The connecting portion 804 of the channel rail 800 cooperates with the first channel rail support 603a and the second channel rail support 603b, thereby coupling the channel rail 800 to the second channel rail fixing unit 600b.

The channel rail support unit 603 may include a contact surface 604 which is provided at the top of the channel rail support unit 603 and contacts the channel rail protrusion 803 of the channel rail 800.

That is, the contact surface 604 of the channel rail support unit 603 and the contact surface 805 of the channel rail protrusion 803 of the channel rail 800 may contact each other. Since the second channel rail fixing unit 600b and the channel rail 800 may both be formed of a plastic material, the coefficient of friction at the contact or interface between the second channel rail fixing unit 600b and the channel rail 800 may be reduced, and thus, the channel rail 800 and the second channel rail fixing unit 600b may easily move against each other.

That the channel rail 800 and the second channel rail fixing unit 600b may freely move against each other may mean that the second channel rail fixing unit 600b may slidably move along the channel rail 800, and particularly, that the contact surface 604 of the channel rail support unit 603 may slidably move against the contact surface 805 of the channel rail protrusion 803. In at least one embodiment, the cooperation of these components creates a slidable interlocking engagement between the channel rail 800 and channel rail fixing unit 600.

The second channel rail fixing unit 600b and the channel rail 800 may be formed of, but is not limited to, a plastic material, such as polycarbonate (PC) or polypropylene (PP). For example, the second channel rail fixing unit 600b may be formed of PP, and the channel rail 800 may be formed of PC.

The second spoiler 500b may be formed in one body with, and thus coupled to, the second channel rail fixing unit 600b. Accordingly, to couple the second channel rail fixing unit 600b to the channel rail 800, the channel rail support unit 603 and the recess 601 may be provided in the second channel rail fixing unit 600b.

Since the second channel rail fixing unit 600b and the channel rail 800 are formed of a plastic material, the coefficient of friction at the contact surface (or the interface) between the second channel rail fixing unit 600b and the channel rail 800 may be reduced, and thus, the channel rail 800 and the second channel rail fixing unit 600b may freely move against each other.

In addition, as mentioned above, the rigidity of the second channel rail fixing unit 600b may be determined in consideration of the rigidity of the second spoiler 500b such that the second channel rail fixing unit 600b does not interfere with the pressing pressure on the adhering member 900. For example, the second channel rail fixing unit 600b and the rigidity of the second spoiler 500b may have a ratio of about 1:1.05 to 1:1.10.

The structure of the second channel rail fixing unit 600b will hereinafter be described.

For convenience, the terms “vertical” and “horizontal” may be used in the description that follows, but should be considered merely exemplary. The terms “vertical direction” and “horizontal direction,” as used herein, may be interchangeable with “first direction” and “second direction,” respectively.

Referring further to FIGS. 3A and 3B, the second channel rail fixing unit 600b includes the first channel rail support 603a and the second channel rail support 603b.

The second channel rail fixing unit 600b may also include a first vertical extension 605a which extends from the first channel rail support 603a in a first direction, for example, a vertical direction, and a second vertical extension 605b which extends from the second channel rail support 603b in the vertical direction. For convenience, the first vertical extension 605a and the second vertical extension 605b may be collectively referred to as the pair of vertical extensions 605.

The term “vertical direction” as used herein, may be interchangeable with the term “first direction.” Accordingly, the first vertical extension 605a and the second vertical extension 605b may also be referred to as the first “first-directional” extension 605a and the second “first-directional” extension 605b, respectively, and the pair of vertical extensions 605 may also be referred to as the pair of “first-directional” extensions 605.

The second channel rail fixing unit 600b may also include a vertical extension connecting portion 606 which interconnects the first vertical extension 605a and the second vertical extension 605b. The vertical extensions 605 and the vertical extension connecting portion 606 may be provided for strengthening the coupling between the second spoiler 500b and the second channel rail fixing unit 600b. The shape of the second channel rail fixing unit 600b may vary depending on the presence or absence of the vertical extensions 605 and/or the vertical extension connecting portion 606.

The term “vertical direction” as used herein, may be interchangeable with the term “first direction.” Accordingly, the vertical extension connecting portion 606 may also be referred to as the “first-directional” extension connecting portion 606.

The second channel rail fixing unit 600b may a channel rail support unit, which is provided for strengthening the coupling between the second channel rail fixing unit 600b and the second spoiler 500b, which are formed in one body with each other. The channel rail support unit may include a vertical extension connecting portion, which, may increase stiffness and interfere with the pressing pressure on the adhering member 900.

Accordingly, the thickness of the vertical extension connecting portion may be determined such that the vertical extension connecting portion has a desirable stiffness and does not interfere with the pressing pressure on the adhering member 900.

More specifically, the vertical extension connecting portion, i.e. the first-directional extension connecting portion, may be formed to be thinner than the channel rail support unit.

For example, a thickness d1 of the vertical extension connecting portion 606 may be determined in consideration of a thickness d2 of the channel rail support unit 603 such that the thickness d1 and the thickness d2 may have a ratio d2:d1 of about 1:0.1 to 1:0.9.

In response to the ratio of the thickness d1 and the thickness d2, d2:d1, being less than 1:0.1, the vertical extension connecting portion 606 may not be able to properly support and strengthen the coupling between the second spoiler 500b and the second channel rail fixing unit 600b. On the other hand, in response to the ratio of the thickness d1 and the thickness d2, d2:d1, being greater than 1:0.9, the vertical extension connecting portion 606 may undesirably interfere with the pressing pressure on the adhering member 900.

In a non-limiting example, the thickness d2 may be about 0.1-2 mm, and the thickness d1 may be about 0.01-1.8 mm.

However, the thicknesses of the vertical extension connecting portion 606 and the channel rail support unit 603 are not limited to the numeric ranges as set forth herein. For example, in response to the thickness of the channel rail support unit 603 being determined in accordance with the specification of the wiper blade assembly 10, the thickness of the vertical extension connecting portion 606 may be appropriately determined to have a predetermined ratio with respect to the thickness of the channel rail support unit 603.

Modified examples of the second channel rail fixing unit 600b will hereinafter be described.

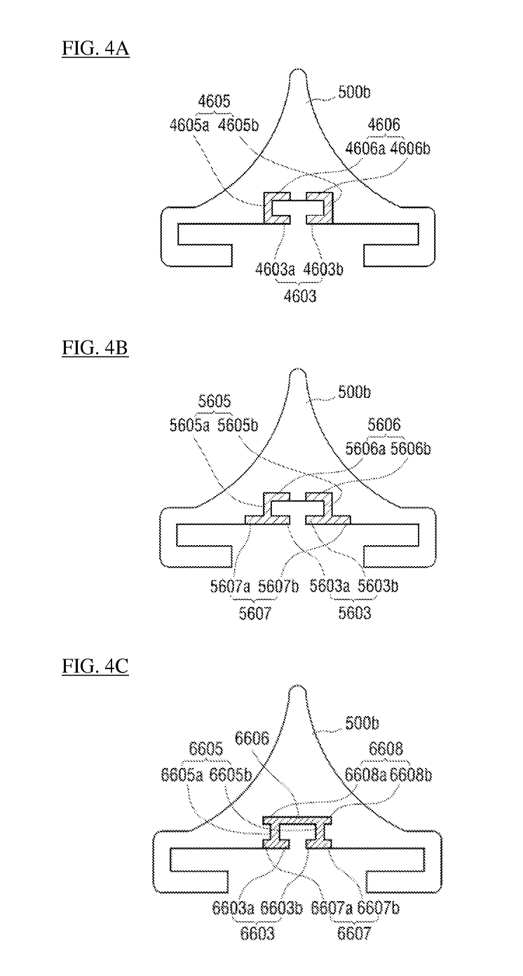

FIG. 4A is a cross-sectional view illustrating a first modified example of the second channel rail fixing unit 600b, FIG. 4B is a cross-sectional view illustrating a second modified example of the second channel rail fixing unit 600b, and FIG. 4C is a cross-sectional view illustrating a third modified example of the second channel rail fixing unit 600b.

Referring to FIG. 4A, the second channel rail fixing unit 600b may include a first channel rail support 4603a and a second channel rail support 4603b. The second channel rail fixing unit 600b may also include vertical extensions 4605, i.e., a first vertical extension 4605a vertically extended from the first channel rail support 4603a and a second vertical extension 4605b vertically extended from the second channel rail support 4603b.

The second channel rail fixing unit 600b may also include one or more vertical extension connecting portions 4606 connected to the first vertical extension 4605a and the second vertical extension 4605b. For example, the second channel rail fixing unit 600b may include a single vertical extension connecting portion 4606, as illustrated in FIG. 3A. In another example such as the illustration of FIG. 4A, the second channel rail fixing unit 600b may include two vertical extension connecting portions 4606, i.e., a first vertical extension connecting portion 4606a connected to the first vertical extension 4605a and a second vertical extension connecting portion 4606b connected to the second vertical extension 4605b, as illustrated in FIG. 4A.

Referring to FIG. 4B, the second channel rail fixing unit 600b may include a first channel rail support 5603a and a second channel rail support 5603b. The second channel rail fixing unit 600b may also include vertical extensions 5605, i.e., a first vertical extension 5605a vertically extended from the first channel rail support 5603a and a second vertical extension 5605b vertically extended from the second channel rail support 5603b.

The second channel rail fixing unit 600b may also include vertical extension connecting portions 5606, i.e., a first vertical extension connecting portion 5606a connected to the first vertical extension 5605a and a second vertical extension connecting portion 5606b connected to the second vertical extension 5605b.

The second channel rail fixing unit 600b may also include horizontal extensions 5607, i.e., a first horizontal extension 5607a horizontally extended from the first channel rail support 5603a and a second horizontal extension 5607b horizontally extended from the second channel rail support 5603b.

The term “horizontal direction”, as used herein, may be interchangeable with the term “second direction”. Accordingly, the first horizontal extension 5607a and the second horizontal extension 5607b may also be referred to as the first second-directional extension 5607a and the second second-directional extension 5607b, respectively, and the horizontal extensions 5607 may also be collectively referred to as the second-directional extensions 5607.

The term “horizontal direction”, as used herein, may be interchangeable with the term “second direction”. Accordingly, the first vertical extension 605a and the second vertical extension 605b may also be referred to as the first first-directional extension 605a and the second first-directional extension 605b, respectively, and the vertical extensions 605 may also be collectively referred to as the first-directional extensions 605.

As described above, the shape of a channel rail fixing unit may vary depending on the presence or absence of first horizontal extensions, vertical extensions, vertical extension connecting portions, and second horizontal extensions, and thus should not be construed as being limited to those particular configurations set forth herein.

Referring to FIG. 4C, the second channel rail fixing unit 600a may include a first channel rail support 6603a and a second channel rail support 6603b. The second channel rail fixing unit 600b may also include vertical extensions 6605, i.e., a first vertical extension 6605a vertically extended from the first channel rail support 6603a and a second vertical extension 6605b vertically extended from the second channel rail support 6603b.

The second channel rail fixing unit 600b may also include first horizontal extensions 6607, i.e., a first horizontal extension 6607a horizontally extended from the first channel rail support 6603a and a second horizontal extension 6607b horizontally extended from the second channel rail support 6603b.

The second channel rail fixing unit 600b may also include a vertical extension connecting portion 6606 connected to the first vertical extension 6605a and the second vertical extension 6605b. The vertical extension connecting portion 6606 may include second horizontal extensions, i.e., a first horizontal extension 6608a horizontally extended from the vertical extension connecting portion 6606 in one direction and a second horizontal extension 6608b horizontally extended from the vertical extension connecting portion 6606 in the other direction.

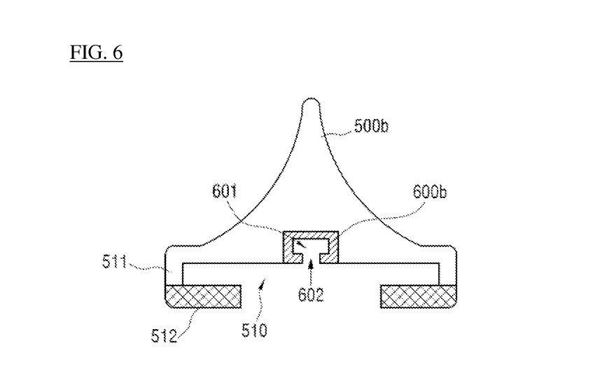

FIG. 6 is a coupled cross-sectional view taken along line I-I of FIG. 2A. More specifically, FIG. 6 illustrates a modified example of the second spoiler 500b.

The description of FIGS. 3A and 3B is also applicable to FIG. 6, and thus will not be repeated here.

Referring to FIG. 6, the second spoiler 500b, which is provided for covering the elastic member 700, accommodates therein the second channel rail fixing unit 600b for fixing the channel rail 800.

The second spoiler 500b, like its counterpart illustrated in FIGS. 3A and 3B, includes an elastic member insertion unit 510 which is provided at the bottom of the second spoiler 500b and into which the elastic member 700 is inserted. The elastic member insertion unit 510 may be configured to provide space for accommodating an elastic member support unit which supports the elastic member 700. The elastic member support unit may include an elastic member vertical support 511 supporting the lateral sides of the elastic member 700 and an elastic member horizontal support 512 supporting the bottom of the elastic member 700. In at least one embodiment, the horizontal support 512 comprises a pair of opposing wrapping portions that cover outer edges of the elastic member 700.

The second spoiler 500b and the second channel rail fixing unit 600b may be formed in one body with each other by double extrusion or co-extrusion, and may thus be fixed to each other.

In the second spoiler 500b, unlike in its counterpart illustrated in FIGS. 3A and 3B, the elastic member vertical support 511 and the elastic member horizontal support 512 may be formed in one body with each other by double extrusion, and may thus be fixed to each other.

The elastic member vertical support 511 may be formed of a typical spoiler material such as Santoprene, and the elastic member horizontal support 512 may be formed of the same material as the second channel rail fixing unit 600b, for example, PC or PP.

The elastic member 700 may be inserted into the elastic member insertion unit 510, and may thus be prevented from the second spoiler 500b by being supported by the elastic member horizontal support 512. When the elastic member 700 is inserted into, and thus supported by, the second spoiler 500b, more force may be applied to the horizontal support 512 than to other portions of the second spoiler 500b.

Accordingly, the elastic member horizontal support 512 may be formed of a more rigid material than the rest of the second spoiler 500b, and may thus be able to firmly support the elastic member 700.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wiper blade assembly, comprising:
an adhering member;
an elastic member configured to support the adhering member;
a channel rail configured to be coupled to the adhering member; and
spoilers configured to cover the elastic member and include channel rail fixing units which fix the channel rail, wherein each of the channel rail fixing units includes a channel rail support unit supporting the channel rail, first-directional extensions extended from the channel rail support unit in a first direction, and at least one first-directional extension connecting portion connected to the first-directional extensions, and wherein each of the first-directional extensions is thinner than the channel rail support unit.

2. The wiper blade assembly of claim 1, wherein the first-directional extensions are vertical extensions, the first-directional extension connecting portion is a vertical extension connecting portion, the channel rail support unit further comprises a first channel rail support and a second channel rail support disposed in parallel with the first channel rail support, and the vertical extensions include a first vertical extension vertically extended from the first channel rail support and a second vertical extension vertically extended from the second channel rail support, and the vertical extension connecting portion includes a first vertical extension connecting portion connected to the first vertical extension and a second vertical extension connecting portion connected to the second vertical extension.

3. The wiper blade assembly of claim 1, wherein the elastic member comprises a first elastic element, a second elastic element disposed in parallel with the first elastic element, and a channel rail insertion hole disposed between the first elastic element and the second elastic element, and the channel rail fixing units fix the channel rail with a predetermined portion of the channel rail inserted into the channel rail insertion hole.

4. The wiper blade assembly of claim 3, wherein the channel rail further comprises a body, a channel rail protrusion disposed at an upper part of the channel rail, and a connecting portion connecting the body and the channel rail protrusion, and each of the channel rail fixing units further comprises a channel rail protrusion receiving part into which the channel rail protrusion is inserted, and the channel rail is coupled to the channel rail fixing units by inserting the channel rail protrusion into the channel rail protrusion receiving part.

5. The wiper blade assembly of claim 4, wherein the channel rail support unit including a first channel rail support, a second channel rail support disposed in parallel with the first channel rail support, and an insertion hole disposed between the first channel rail support and the second channel rail support, and the channel rail is coupled to the channel rail fixing units by inserting the channel rail protrusion into the channel rail protrusion receiving part and coupling the connecting portion into the insertion hole.

6. The wiper blade assembly of claim 5, wherein the channel rail protrusion further comprises a contact surface formed at a bottom thereof to contact a surface of the channel rail support, the channel rail support unit further comprises a contact surface formed at a top thereof to contact a surface of the channel rail protrusion, and the contact surface of the channel rail protrusion and the contact surface of the channel rail support unit contact each other.

7. The wiper blade assembly of claim 1, wherein the channel rail fixing units are respectively formed in one body with the spoilers and the channel rail fixing units and the channel rail are formed of a plastic material.

8. The wiper blade assembly of claim 1, wherein a thickness (d1) of the channel rail support unit and a thickness (d2) of the first-directional extension connecting portions have a ratio d2:d1 of about 1:0.1 to 1:0.9.

9. The wiper blade assembly of claim 1, wherein a rigidity of the spoilers and a rigidity of the channel rail fixing units have a ratio of about 1:1.05 to 1:1.10.

10. The wiper blade assembly of claim 1, wherein the channel rail fixing units slidably move along the channel rail.

11. A wiper blade assembly comprising:
an adhering member for clearing a glass surface;
a channel rail configured to retain the adhering member and defining a protrusion extending vertically;
an elongate elastic member disposed above the channel rail having at least one slot formed therethrough and configured to receive the protrusion through the at least one slot;
a symmetrical wind spoiler disposed about the elastic member; and
an integral channel rail fixing unit embedded within the wind spoiler and defining channel rail support portions, vertical extensions extending from each of the channel rail support portions, and a connecting portion extending from each of the vertical extensions, wherein the channel rail support portions engage the protrusion and define a thickness greater than a thickness of the connecting portion.

12. The wiper blade assembly of claim 11 wherein the channel rail fixing unit is formed from a first material and is co-extruded with the wind spoiler formed from a second material, and the first material has a rigidity greater than a rigidity of the second material.

13. The wiper blade assembly of claim 12 wherein the rigidity of the first material and the rigidity of the second material have a ratio of about 1:1.05 to 1:1.10.

14. The wiper blade assembly of claim 11 wherein the connecting portion of the channel rail fixing unit comprises a pair of laterally opposing connecting portions defining a distance therebetween.

15. The wiper blade assembly of claim 11 wherein the connecting portion of the channel rail fixing unit interconnects each of the vertical extensions.

16. The wiper blade assembly of claim 11 wherein the thickness of the channel rail support portions and a thickness of the connecting portion define a ratio of about 1:0.1 to 1:0.9.

17. A wiper blade assembly comprising:
an adhering member for clearing a glass surface;
a channel rail configured to retain the adhering member and defining a protrusion extending vertically;
an elongate elastic member disposed above the channel rail having at least one slot formed therethrough and configured to receive the protrusion through the at least one slot;
a symmetrical wind spoiler disposed about the elastic member; and
a generally rectangular channel rail fixing unit embedded within the wind spoiler defining horizontal channel rail support portions, vertical extensions extending from each of the channel rail support portions, and a horizontal connecting portion interconnecting each of the vertical extensions, wherein the channel rail support portions define an opening to receive the protrusion and engage contact surfaces of the protrusion thereby interlocking the channel rail with the channel rail fixing unit.
